(19) United States
(12) Patent Application Publication
(10) Pub. No.: US 2013/0103747 A1
(43) Pub. Date: Apr. 25, 2013

(54) POSTED INFORMATION SHARING SYSTEM, INFORMATION-PROCESSING DEVICE, STORAGE MEDIUM, SERVER, INFORMATION-PROCESSING METHOD, AND INFORMATION-PROCESSING SYSTEM

(71) Applicant: NINTENDO CO., LTD.,, Kyoto (JP)

(72) Inventors: Kiyoshi MIZUKI, Kyoto (JP); Hideto YUZAWA, Kyoto (JP); Shunsaku KATO, Kyoto (JP)

(73) Assignee: NINTENDO CO., LTD.,, Kyoto (JP)

(21) Appl. No.: 13/653,661

(22) Filed: Oct. 17, 2012

(30) Foreign Application Priority Data
Oct. 19, 2011 (JP) 2011-229401
May 31, 2012 (JP) 2012-124306

(51) Int. Cl. G06F 15/16

(52) U.S. Cl. 709/203

(57) ABSTRACT

An exemplary information-processing device includes: an executing unit configured to execute an application program; a storage unit configured to store usage information or progress information, the usage information showing a usage status of the application program, the progress information showing a progress status of the application program; a generating unit configured to generate posted information relating to the application program, based on an input by a user; and a transmitting unit configured to transmit to a server the posted information along with first information, the first information being based on the usage information or the progress information that is stored in the first storage unit and corresponds to the application program.

### CROSS REFERENCE TO RELATED APPLICATIONS

This application is based on and claims priorities under 35 USC 119 from Japanese patent applications No. 2011-229401, which was filed on Oct. 19, 2011, and No. 2012-124306, which was filed on May 31, 2012.

### FIELD

The technology herein relates to sharing posted information.

### BACKGROUND AND SUMMARY

An information-processing device having a communication function for communicating with another user is known.

The present disclosure provides a technology for providing to a user objective materials for determining reliability of posted information.

There is provided a posted information sharing system including an information-processing system and a server. The information-processing system includes: an executing unit configured to execute an application program; a first storage unit configured to store usage information or progress information, the usage information showing a usage status of the application program and the progress information showing a progress status of the application program; a generating unit configured to generate posted information relating to the application program, based on an input by a user; a first transmitting unit configured to transmit to the server the posted information along with first information, the first information being based on the usage information or the progress information that is stored in the first storage unit and corresponding to the application program; and a requesting unit configured to transmit a request to the server to transmit posted information. The server includes: a first receiving unit configured to receive the posted information and the first information transmitted from the information-processing system; a second storage unit configured to store the posted information and information showing the usage status or the progress status relating to the posted information, based on the first information received by the first receiving unit; and a second transmitting unit configured to transmit, in response to the request transmitted from the information-processing system, the posted information along with second information, the second information being based on the usage status or the progress status relating to the posted information. The information-processing system further includes: a second receiving unit configured to receive the posted information and the second information transmitted from the server; and a display control unit configured to control a display to display the posted information and the usage status or the progress status relating to the posted information, based on the posted information and the second information received by the second receiving unit.

### BRIEF DESCRIPTION OF THE DRAWINGS

Exemplary embodiments will be described with reference to the following drawings, wherein:

FIG. 1 shows an example of an outline of a posted information sharing system according to an exemplary embodiment;

FIG. 2 shows an example of a screen image of the posted information sharing service;

FIG. 3 shows exemplary details of posted information 94;

FIG. 4 shows an example of a configuration of posted information sharing system 1 according to one exemplary embodiment;

FIG. 5 shows an example of a function of information-processing device 10, relating to transmitted posted information;

FIG. 6 shows an example of a functional configuration of information-processing device 10, for browsing the posted information;

FIG. 7 shows an example of a hardware configuration of information-processing device 10;

FIG. 8 shows an example of a software configuration of information-processing device 10;

FIG. 9 shows an example of a functional configuration of post server 20;

FIG. 10 shows examples of methods for accessing post server 20;

FIG. 11 shows an example of a sequence chart illustrating an operation of information-processing device 10;

FIG. 12 shows an example of data stored in posted information database 212;

FIG. 13 shows an example of a software configuration relating to path 3;

FIG. 14 shows an example of a sequence chart illustrating a process for browsing the posted information relating to a community;

FIG. 15 shows an example of a community list;

FIG. 16 shows an example of a sequence chart illustrating a process for viewing a direct message;

FIG. 17 shows an example of a sequence chart illustrating a process for posting text;

FIG. 18 shows an example of a sequence chart illustrating a process for posting information including a set of binary data; and

FIG. 19 shows an example of a sequence chart illustrating a process for posting a direct message.

### DETAILED DESCRIPTION OF NON-LIMITING EXEMPLARY EMBODIMENTS

### 1. Outline

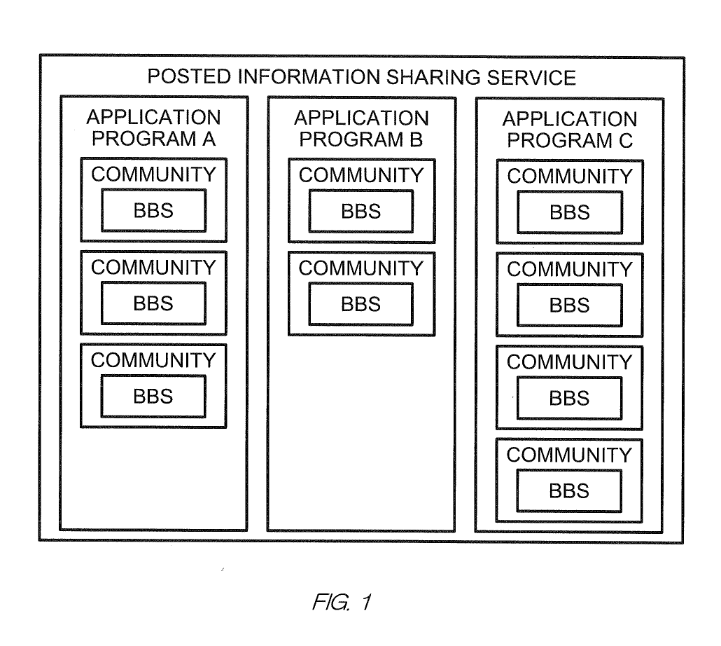

FIG. 1 shows an outline of posted information sharing system according to an exemplary embodiment. A service provided by the posted information sharing system (hereinafter, referred to as “posted information sharing service”) includes, for example, a so-called electronic bulletin board system (hereinafter, the electronic bulletin board is simply referred to as “bulletin board”). The bulletin board is a system for receiving posted information posted by a user from a terminal and storing the posted information, as well as providing the posted information in a browsable format to a user who accesses a server from a terminal. It is to be noted that a server function may be provided by a single server device or a group of server devices. The posted information sharing system may share the posted information by use of another system, for example, by providing access by another user to a web site unique to a user, to which the user posts information, or by providing a system for another user to post comments on the posted information. According to the bulletin board system, at least one unique bulletin board is provided for every application program. Further, each application program has at least one unique community relating to the application program. It is to be noted that each application program may have plural unique communities. A community is, for example, a group of users (in other words, a set of plural users). A user who belongs to a community is referred to as a member of the community. In this example, at least one unique bulletin board is provided for each community.

In this example, at least one community is provided for each application program. In other words, a provider or an operator of the posted information sharing system generates on a server at least one unique community for each application program. More specifically, when a new application program is released, the provider or the operator generates on a server at least one unique community for the new application program. Thus, at least one unique community and at least one unique bulletin board is provided by a server for every commercially available application program (in other words, every application program in use). n communities (n is a natural number that satisfies n≧1) correspond to an application program. In the example shown in FIG. 1, three communities exist for application program A, and two communities exist for application program B. Each community has a communication tool (for example, a bulletin board) for communicating with other members. A member communicates a message such as an opinion, an impression, a question, a comment, and so on, with other members. In other words, a user of the posted information sharing system can browse comments of other members, share his/her comments, or exchange messages with other members.

A user of the posted information sharing system can establish a relationship with another user as a “friend.” The term “friends” refers to a relationship between two users who have agreed via the posted information sharing system to be friends with each other.

FIG. 2 shows an example of a screen image of the posted information sharing service; more specifically, it shows a screen image of the communication tool in a community. The image includes title 91, text box 92, post button 93, plural items of posted information 94, and buy button 95. In other words, the image includes a user interface for the bulletin board system. Title 91 shows a title of the community. In this example, the application program is a program for providing a video game (in other words, a game application), and title 91 includes information (at least one of text and image) for identifying the application program to which the community belongs. In this example, title 91 shows that the community relates to a game of “the Legend of XYZ.” Text box 92 is used to input a text to be posted. Post button 93 is used to input an instruction to transmit data such as the text input in text box 92, to the posted information sharing system (server). Posted information 94 shows information posted by a user. Details of posted information 94 will be described later. Buy button 95 is used to input an instruction to access a web site on which a corresponding application program is sold.

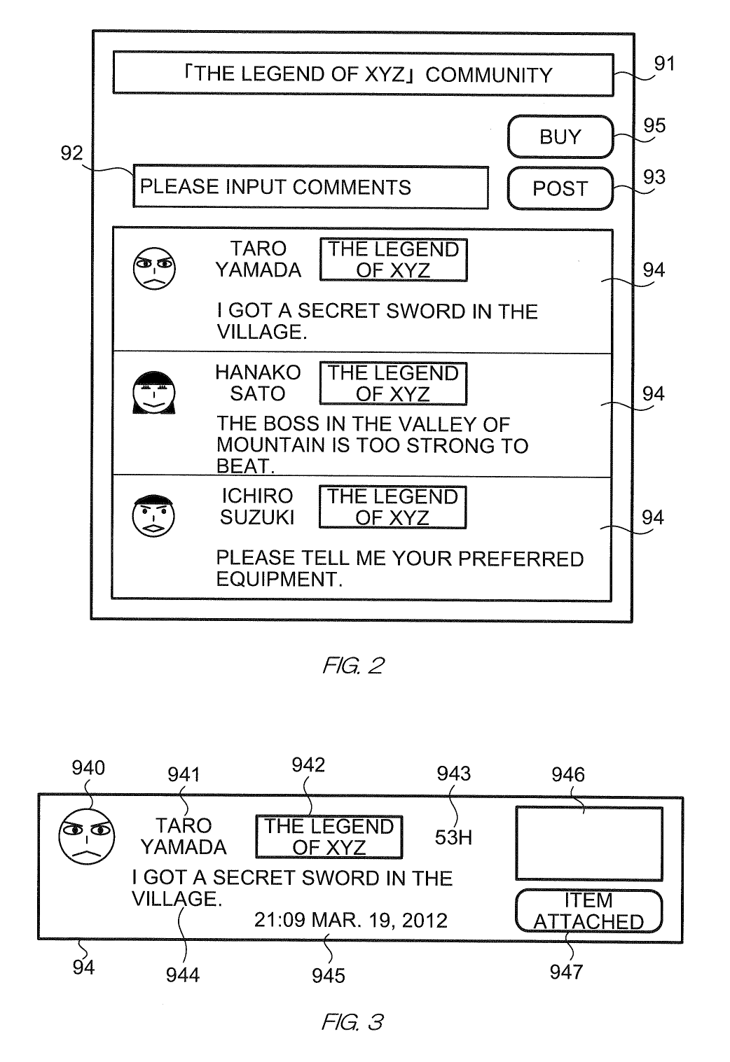

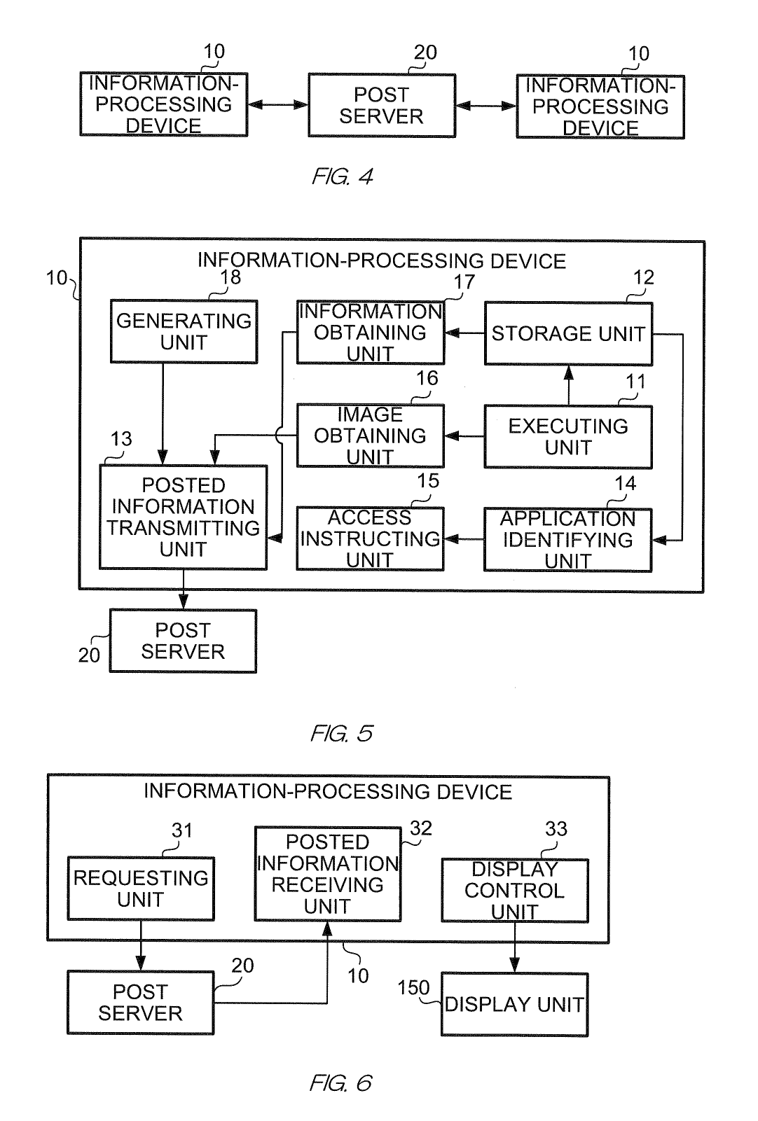

FIG. 3 shows exemplary details of posted information 94. Posted information 94 includes user image 940, user ID 941, application name 942, progress information 943, posted text 944, time stamp 945, screen shot image 946, and attached data image 947. User image 940 shows an image set up for a user who transmits this posted information 94. In this example, the user image is a so-called avatar image. User ID 941 denotes a name of a user who posts this posted information 94. Application name 942 denotes information identifying an application program that is in executing state in the user's information-processing device at the time an instruction to transmit this posted information 94 is made. Here, the term “executing state” includes a state in which execution of the application program is suspended or paused (in other words, the execution is temporarily disrupted) as well as a state in which the application program is being executed (in other words, the execution is sustained). Hereinafter, the application is referred to as an “application program in the executing state (at the time of transmission).”

Progress information 943 denotes a progress status of an application program in the progress status, for example, a stage number (stage name), a save point, or accumulated playing time of a game. Posted text 944 shows a text input by a user who posted this posted information 94. Time stamp 945 denotes a time when this posted information 94 was posted. Usually, posted text 944 is a text of an opinion, an impression, a question, or a comment relating to the application program in the executing state. In other words, posted text 944 is a text relating to an application program denoted by application name 942.

Screen shot image 946 is a screen shot image of an application program in the executing state. Attached data image 947 denotes whether data relating to this item of posted information 94 is attached. The attached data is generated by the application program in the executing state and shows, for example, a virtual object such as an item in a game.

In the example of posted information 94 shown in FIG. 3, it is shown that a user having a user ID “Taro Yamada” posted a text “I got a secret sword in the village.” relating to a game “Legend of XYZ” at 21:09, Mar. 19, 2021.

It is to be noted that the posted information sharing service is an example of a service for providing the posted information. The posted information may be provided by, for example, a blog or a buzz marketing site. Further, in FIG. 1, a single service has plural communities relating to plural application programs. However, plural services, each of which is unique for an application program, for sharing the posted information may be provided.

It is to be noted that the posted information sharing service provides a user interface image independent of the application program as well as a user interface image corresponding to a community. A page referred to as “my page” is an example of the user interface image independent of the application program. In “my page,” plural items of posted information posted by other users who are friends of the user or have association with the user, are shown in a single user interface image.

### 2. Configuration

### 2-1. Posted Information Sharing System 1

FIG. 4 shows an example of a configuration of posted information sharing system 1 according to one exemplary embodiment. Posted information sharing system 1 includes information-processing device 10, post server 20, and shop server 30. Post server 20 is a server device providing a posted information sharing service. Post server 20 includes a function to provide a bulletin board system. Post server 20 stores information posted (transmitted) from information-processing device 10 as the posted information. Further, if post server 20 receives a request for browsing the posted information, post server 20 provides the posted information. More specifically, when an item of information is posted, the item of posted information is stored in a resource (for example, a directory) corresponding to (dependent on) an application program in the executing state at the time of the post. Alternatively, all the posted information may be stored in a single resource with identification information of the application program being stored. Further, if post server 20 receives a request for browsing the posted information, post server 20 reads the requested posted information from corresponding resources in the post server 20, in response to an application program in the executing state. Thus, post server 20 provides the posted information to a terminal that transmits a request to browse the posted information. In posted information sharing system 1, each of plural users transmits his/her own posted information to post server 20 from his/her own information-processing device 10. Post server 20 stores the posted information transmitted from plural information-processing devices 10. Post server 20 transmits at least one item of posted information selected in response to a request from among the stored plural items of posted information, to information-processing device 10 that is a source of the request. The posted information includes, for example, text that is input by a user. The posted information includes text (character strings) and/or an image as an opinion, an impression, a question, a comment, or a message. Shop server 30 sells an application program by download via a network in response to a request from information-processing device 10.

Information-processing device 10 includes a function to execute at least one application program selected from plural application programs Information-processing device 10 obtains identification information of an application program from among the plural application programs. Hereinafter, an application program that is in the executing state at the time a post instruction or a browse instruction is input, is referred to as an “application in the executing state.” In the exemplary embodiment, information-processing device 10 accesses post server 20 after the application in the executing state is paused. Therefore, the application in the executing state is an application program that was being executed immediately prior to input of an instruction to access post server 20. In this example, information-processing device 10 obtains identification information of an application program that is paused at the time of the access. However, the application program may still be being executed at the time of the access. In such a case, information-processing device 10 obtains identification information of an application program that is being executed at the time of the access. Information-processing device 10 accesses a community corresponding to an application in the executing state, and displays results of the access. Here, “at the time an instruction to access post server 20 is made” includes a timing when an indirect instruction to access post server 20 is made, for example, when an instruction to display a menu image including an item to access post server 20 is made, as well as a timing when a direct instruction to access is made. Also, the “access to post server 20” includes access to transmit information and access to browse the posted information. Only one of these two accesses may be implemented in a single device or by a single software program. Here, “when an instruction to access is made” includes at least one of when an instruction to transmit the posted information is made and when an instruction to browse the posted information is made. Further, an “application in the executing state” includes at least one of an application program that is being executed and an application program whose execution is paused (suspended).

### 2-2. Information-Processing Device 10

### 2-2-1. Functional Configuration

Information-processing device 10 has a function to transmit posted information to post server 20, and a function to browse (receive) posted information on (from) post server 20. These functions will be described in the following.

### 2-2-1-1. Transmission Function

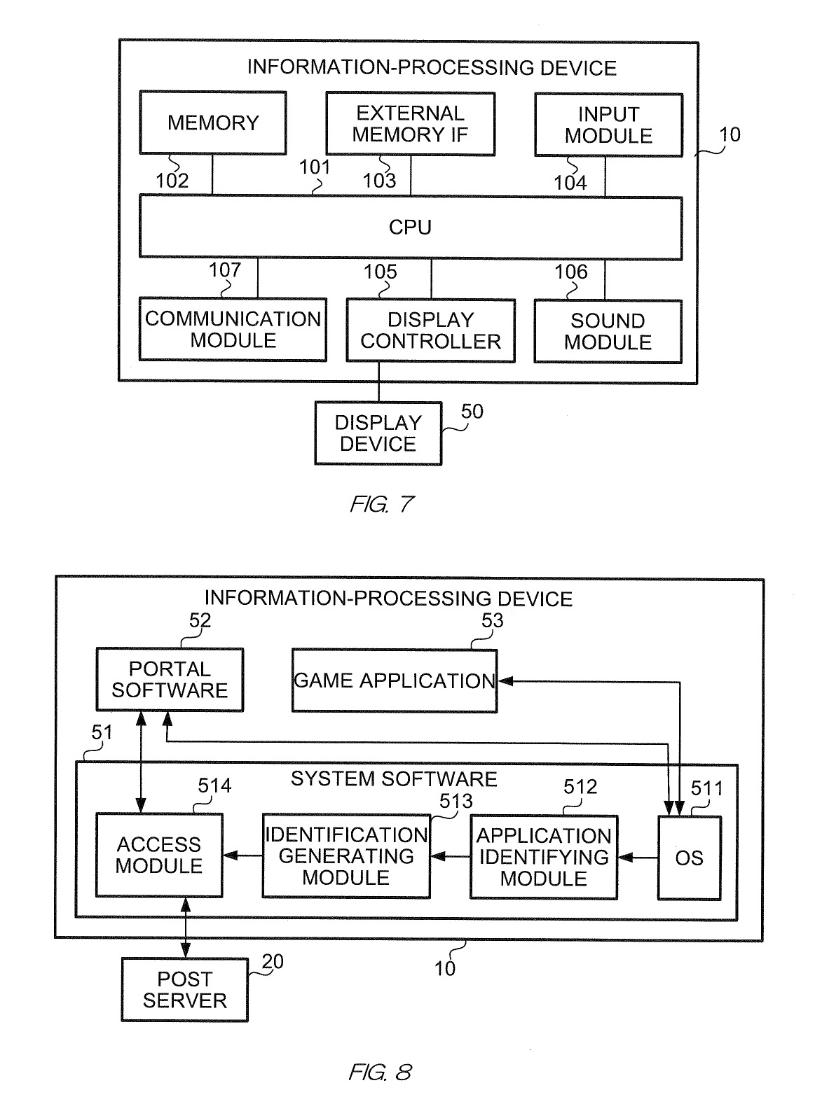

FIG. 5 shows a function in information-processing device 10, relating to transmission of posted information. Information-processing device 10 includes executing unit 11, storage unit 12, posted information transmitting unit 13, and generating unit 18. Executing unit 11 executes an application program. Storage unit 12 stores usage information or progress information relating to an application program that is executed by executing unit 11. Usage information and progress information show a usage status and a progress status of the application program that is executed by executing unit 11, respectively.

Generating unit 18 generates posted information in response to an input by a user. Posted information transmitting unit 13 transmits to post server 20 the posted information generated by generating unit 18, and information (an example of first information) based on the usage information or the progress information stored in storage unit 12. Posted information is information input by a user, relating to an application program being executed by executing unit 11. It is to be noted that, if there is neither usage information nor progress information in storage unit 12, posted information transmitting unit 13 may transmit information (another example of the first information) showing there is neither usage information nor progress information in storage unit 12. Alternatively, posted information transmitting unit 13 may transmit information that is generated by processing of the usage information or the progress information stored in storage unit 12, instead of the actual usage information or progress information. For example, in a case that accumulated playing time is stored in storage unit 12 as the usage information, posted information transmitting unit 13 may transmit information (yet another example of the first information) showing whether the user has an experience of playing the game, instead of the accumulated playing time itself.

In this example, information-processing device 10 further includes application identifying unit 14. Application identifying unit 14 identifies an application program in the executing state in executing unit 11. Posted information transmitting unit 13 transmits to server 20 the posted information input by a user, relating to the application program identified by application identifying unit 14, and the corresponding usage information or progress information.

In this example, information-processing device 10 further includes access instructing unit 15. Access instructing unit 15 instructs information-processing device 10 to access post server 20. Application identifying unit 14 identifies an application program in the executing state in executing unit 11 when access is instructed by access instructing unit 15.

In this example, information-processing device 10 further includes image obtaining unit 16. Image obtaining unit 16 obtains a screen shot image of the application program in the executing state in executing unit 11 when access is instructed by access instructing unit 15. Posted information transmitting unit 13 transmits to post server 20 the screen shot image obtained by image obtaining unit 16 as well as the posted information, and the corresponding usage information or progress information stored in storage unit 12.

In this example, information-processing device 10 further includes information obtaining unit 17. Information obtaining unit 17 obtains from storage unit 12 the usage information or the progress information relating to the application program in the executing state in executing unit 11 at a predetermined timing relating to transmission of the posted information. Posted information transmitting unit 13 transmits to post server 20 the posted information and the usage information or the progress information obtained by information obtaining unit 17.

### 2-2-1-2. Browsing Function

FIG. 6 shows a functional configuration of information-processing device 10, for browsing the posted information. Information-processing device 10 includes requesting unit 31, posted information receiving unit 32, and display control unit 33. Information-processing device 10 is connected to display unit 150. Display unit 150 displays an image showing results of the process by a program such as an application program. It is to be noted that, although display unit 150 is external to information-processing device 10, information-processing device 10 itself may include display unit 150.

Requesting unit 31 transmits to post server 20 a request for browsing the posted information. Posted information receiving unit 32 receives the posted information and the corresponding usage information or progress information that are transmitted from post server 20 in response to the request. It is to be noted that the received information may include information that is generated by processing the usage information or the progress information. Display control unit 33 displays on display unit 150 the posted information and the corresponding usage information or progress information (or processed information thereof), with their relationship being visible.

### 2-2-2. Hardware Configuration

FIG. 7 shows an example of a hardware configuration of information-processing device 10. In this example, information-processing device 10 is a game device for playing a video game. Information-processing device 10 is a computer device including CPU (Central Processing Unit) 101, memory 102, external memory IF 103, input module 104, display controller 105, sound module 106, and communication module 107. Information-processing device 10 is connected to display device 50. Display device 50 is a device for displaying information such as an image and/or a character string, and includes a display (liquid crystal display panel or organic electro-luminescence display panel) and a driver circuit thereof. In this example, information-processing device 10 is a so-called console type game device, that does not include display device 50. Display device 50 is an external device, such as a television. It is to be noted that information-processing device 10 may include display device 50.

CPU 101 is a device for controlling elements of information-processing device 10, and executes various processes or calculations. Memory 102 is a storage device for storing a program and data, such as RAM (Random Access Memory) and/or ROM (Read Only Memory), for example. External memory IF 103 is an interface for reading/writing data from/into an external storage medium (an optical disk, a magnetic disk, or a semiconductor memory, for example) that stores a program and/or data. Input module 104 includes an input device for inputting an instruction or command from a user to CPU 101, such as, for example, a keypad, buttons, a touch screen, a microphone, or a combination thereof. Display controller 105 is a device for controlling a display device to display information such as an image and/or a character string, such as an image processing circuit and an image signal output circuit. Sound module 106 includes a device for outputting a sound signal, such as a sound processing device and a sound signal output device. Communication module 107 includes a device for communicating with another device in a predetermined communication standard via a wired and/or a wireless network (for example, the Internet).

### 2-2-3. Software Configuration

FIG. 8 shows an example of a software configuration of information-processing device 10. Information-processing device 10 includes system software 51, portal software 52, and game application 53. In this example, system software 51 and portal software 52 are preinstalled in memory 102 before information-processing device 10 is sold. In other words, system software 51 and portal software 52 are provided as functions of a platform of information-processing device 10. Game application 53 is stored in the external storage device. It is to be noted that game application 53 may be stored in memory 102. In another example, at least one of system software 51, portal software 52, and game application 53 may be provided by download via a network and may be updated to the latest version via the network, as an alternative to the preinstall.

System software 51 is software for managing and/or controlling information-processing device 10. System software 51 is software necessary to execute an application program on information-processing device 10, and is software that is necessarily installed in information-processing device 10 when executing an application program. In this example, system software 51 includes OS (Operating System) 511, application identifying module 512, identification generating module 513, and access module 514. System software 51 includes a set of codes to implement the functions. OS 511 is software to manage and/or control portal software 52 and an application program such as game application 53. Application identifying module 512 identifies an application program in the executing state. More specifically, application identifying module 512 obtains identification information (hereinafter referred to as an “application ID”) of an application program in the executing state. Identification generating module 513 generates identification information of a community relating to the application program identified by application identifying module 512. The identification information is, for example, a URL (Uniform Resource Locator) showing a resource of the community. Access module 514 communicates with the resource shown by the URL.

Portal software 52 is client software of the posted information sharing system, and provides a user interface for showing information to a user and receiving input of information by a user. Portal software 52 transmits a request to post server 20 via access module 514, and controls the display device to display an image relating to the posted information sharing system, using data transmitted from post server 20 in response to the request. The image relating to the posted information sharing system includes a UI (User Interface) for inputting, transmitting and displaying the posted information, and at least one item of posted information posted by at least one user.

Game application 53 is an application program (software) for implementing a video game on information-processing device 10. Information-processing device 10 has a function to execute at least one game application selected from various game programs. A program of game application 53 is stored, for example, in the external storage medium (an external memory). A user operates information-processing device to read a program stored in a storage medium that is selected by the user from among plural storage media storing different programs. Thus, the user causes information-processing device 10 to execute the selected game application. In another example, memory 102 stores plural programs. A user may select a program to be started, and cause information-processing device 10 to execute the selected game application.

With regard to the posting function, CPU 101 executing an application program is an example of executing unit 11. Memory 102 and/or the external memory (external storage medium) is an example of storage unit 12. CPU 101 executing access module 514 is an example of posted information transmitting unit 13. CPU 101 executing application identifying module 512 is an example of application identifying unit 14. CPU 101 executing OS 511 is an example of access instructing unit 15. CPU 101 executing portal software 52 is an example of image obtaining unit 16 and information obtaining unit 17.

With regard to the browsing function, CPU 101 executing access module 514 is an example of requesting unit 31 and posted information receiving unit 32. CPU 101 executing portal software 52 is an example of display control unit 33.

### 2-3. Post Server 20

FIG. 9 shows an example of a functional configuration of post server 20. Post server 20 includes storage unit 21, posted information receiving unit 22, and providing unit 23. Storage unit 21 stores user database 211, posted information database 212, and community database 213.

User database 211 is a database for recording user configuration information used for each of plural user IDs of the posted information sharing system. The user configuration information includes configuration information unique to a user; for example, a list of identifications of communities to which the user belongs, a condition for restricting the posted information shared in a community, or a list of user IDs showing users who are friends of the user. The condition includes, for example, a condition of restriction by time (for example, sharing posted information that was posted in the previous week), a condition of restriction by user (for example, sharing posted information that was posted by friends), or a condition of no restriction (sharing all the posted information posted in the previous week).

Posted information database 212 is a database for recording plural items of posted information. Each item of plural posted information corresponds to an application program from among the plural application programs.

Community database 213 is a database for recording information (attribute information) relating to each of the plural communities. Each of the plural communities corresponds to at least one application program. In other words, community database 213 is a database for recording, for each of the plural application programs, information relating to the at least one community corresponding to the application program.

Posted information receiving unit 22 receives the posted information transmitted from posted information transmitting unit 13 and information based on the corresponding usage information or progress information. Storage unit 21 stores in posted information database 212, based on the posted information received by posted information receiving unit 22 and the corresponding information, the posted information and the information showing the corresponding usage status or progress status as well as relationships therebetween. Providing unit 23 transmits to information-processing device 10 that is a source of the request, the posted information stored in storage unit 21 and the information (an example of second information) based on information showing the corresponding usage status or progress status, in response to the request by requesting unit 31.

Post server 20 is a computer having hardware including a CPU and a memory. The CPU is a device for controlling each element of post server 20 and executes various processes. The memory is a device for storing various data and programs, and includes a RAM and a ROM. The memory stores a program (hereinafter referred to as a “post server program”) causing the computer to execute a process for post server 20. By execution of the CPU by the post server program, functions shown in FIG. 9 are implemented.

### 3. Operation

A description will be given of an operation of information-processing device 10. Situations in which information-processing device 10 accesses post server 20 include the following two examples. The first example is where post server 20 is accessed during the execution of game application 53. The second example is where post server 20 is accessed when game application 53 is not being executed. The operations of these two examples will be described below.

### 3-1. Access to Post Server During Execution of Game Application

Here, description is given for an example in which information-processing device 10 accesses a community relating to game application 53 when game application 53 is being executed. In other words, description is given for an example in which a user who is playing the game of game application 53 accesses a community relating to game application 53. In the following description, methods for accessing post server will be described first, and next, a process of the posted information sharing system (how a user can use the posted information sharing system) will be described.

### 3-1-1. Methods for Accessing Post Server

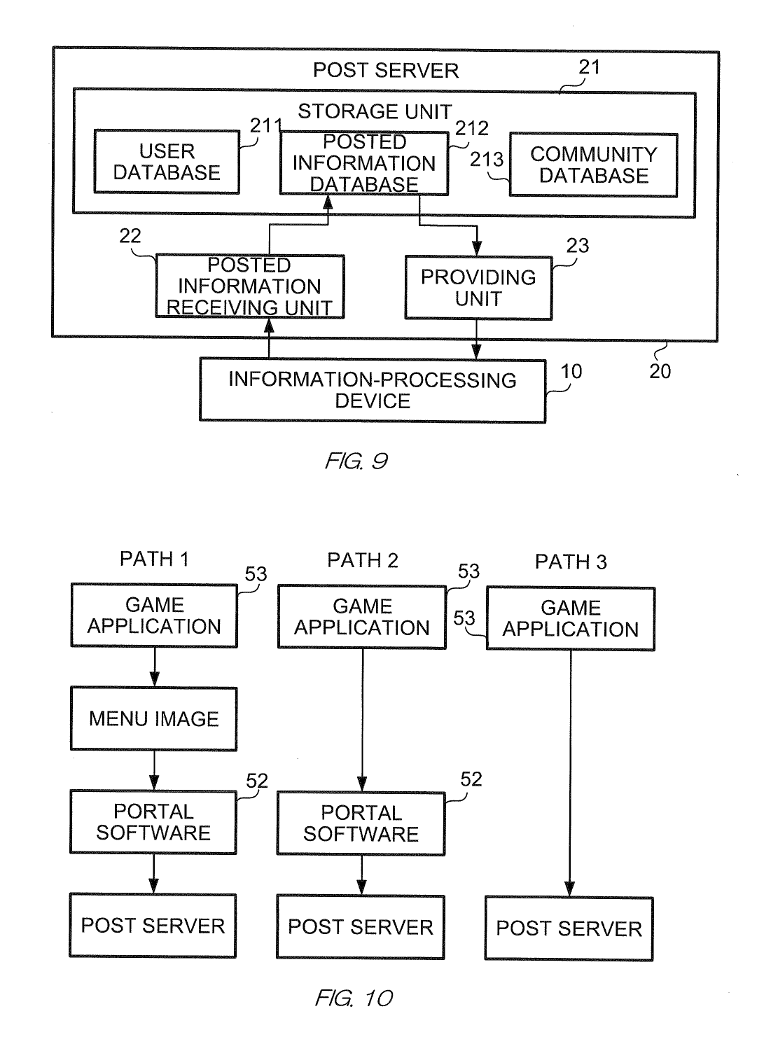

FIG. 10 shows examples of methods for accessing post server 20. The methods for accessing post server 20 are divided into two categories. The first category is to access post server 20 via portal software 52, as shown as paths 1 and 2 in FIG. 10. The second category is to access post server 20 directly from game application 53, as shown as path 3 in FIG. 10. The first category includes two methods. According to the first method, (i) the execution of game application 53 is temporally paused, (ii) a function (for example, a menu image) of system software 51 is called, and (iii) portal software 52 is called via the menu image. The first method is also referred to as path 1. According to the second method, portal software 52 is called directly from game application 53. The second method is also referred to as path 2. Details of these methods will be described below.

### 3-1-1-1. Access Via Portal Software 52

### 3-1-1-1-1. (Path 1) Call Via Menu Image

In this example, OS 511 temporally pauses the execution of game application 53 when a predetermined command is input (for example, a predetermined button from among plural buttons of input module 104 is pushed) when game application 53 is being executed. Then, OS 511 calls a menu image. The menu image is provided by a function of system software 51. The menu image includes an item for instructing portal software 52 to start. If a user selects the item, OS 511 starts portal software 52. The user accesses post server 20 via portal software 52. In this example, after the menu image is called and during the access to post server 20, game application 53 that was being executed is temporarily paused. If a predetermined command is input while game application 53 is paused, OS 511 resumes game application 53.

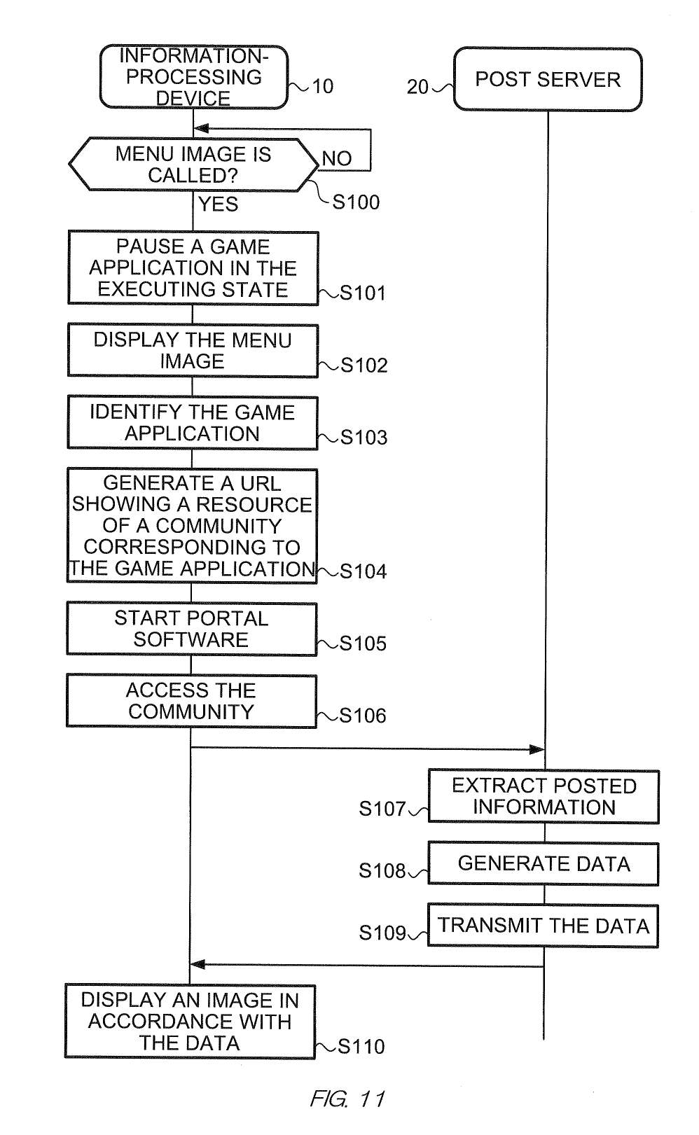

FIG. 11 shows an example of a sequence chart illustrating an operation of information-processing device 10. In the following descriptions, a program such as OS 511 or portal software 52 is described as a subject of the process. These descriptions mean that CPU 101 executing the program co-operates with other hardware devices to execute the process.

In step S100, OS 511 determines whether the menu image is called during the execution of game application 53. In this example, OS 511 monitors input module 104. If a predetermined command is input via input module 104, OS 511 determines whether the menu image is called. If it is determined that the menu image is called (step S100: YES), OS 511 transfers the operation to step S101. If it is determined that the menu image is not called (step S100: NO), OS 511 continues to execute game application 53.

In step S101, OS 511 pauses game application 53 that is being executed. In other words, OS 511 activates another program, with data used for game application 53 being stored in memory 102.

In step S102, OS 511 displays the menu image. The menu image includes an item for instructing portal software 52 to start. If the user selects the item, OS 511 transfers the operation to step S103.

In step S103, application identifying module 512 identifies an application program (an application program in the executing state, in this example, game application 53) that was being executed at the time of input of the instruction to call the menu image. Details are as follows. OS 511 reads from memory 102 the application ID of the application program in the executing state. Then, OS 511 calls application identifying module 512. When calling application identifying module 512, OS 511 notifies application identifying module 512 of the read application ID. It is to be noted that the application ID of the application program in the executing state is stored in memory 102, according to a process independent from the flow shown in FIG. 11. More specifically, when starting an application program, OS 511 obtains the application ID from the application program. OS 511 continues to store the application ID in memory 102 from the start to the termination of the application program.

In step S104, identification generating module 513 generates a URL (an example of community identification information) showing a resource of the corresponding community, using the application program identified by application identifying module 512. Identification generating module 513 includes a table, a function, or a rule for exchanging an application ID for a URL. Identification generating module 513 generates the URL from the application ID with reference to the table, the function, or the rule.

In step S105, OS 511 starts portal software 52. When starting portal software 52, OS 511 notifies portal software 52 of the URL generated by identification generating module 513 as a URL showing a resource that is accessed when the portal software 52 is started.

In step S106, portal software 52 accesses the community shown by the notified URL. In other words, portal software 52 accesses, via access module 514, a resource (in this example, a directory selected from among plural directories of post server 20, in response to the application in the executing state) corresponding to an application program that was being executed at the time when portal software 52 is instructed to start.

When accessing post server 20, access module 514 transmits to post server 20 a request including the application ID and a user ID of the user of information-processing device 10. The user ID is an example of identification information of a user who is logged in to information-processing device 10 (in other words, a user who uses information-processing device 10). The user ID is identified at a predetermined timing, for example, at the time of booting information-processing device 10, by a so-called login process.

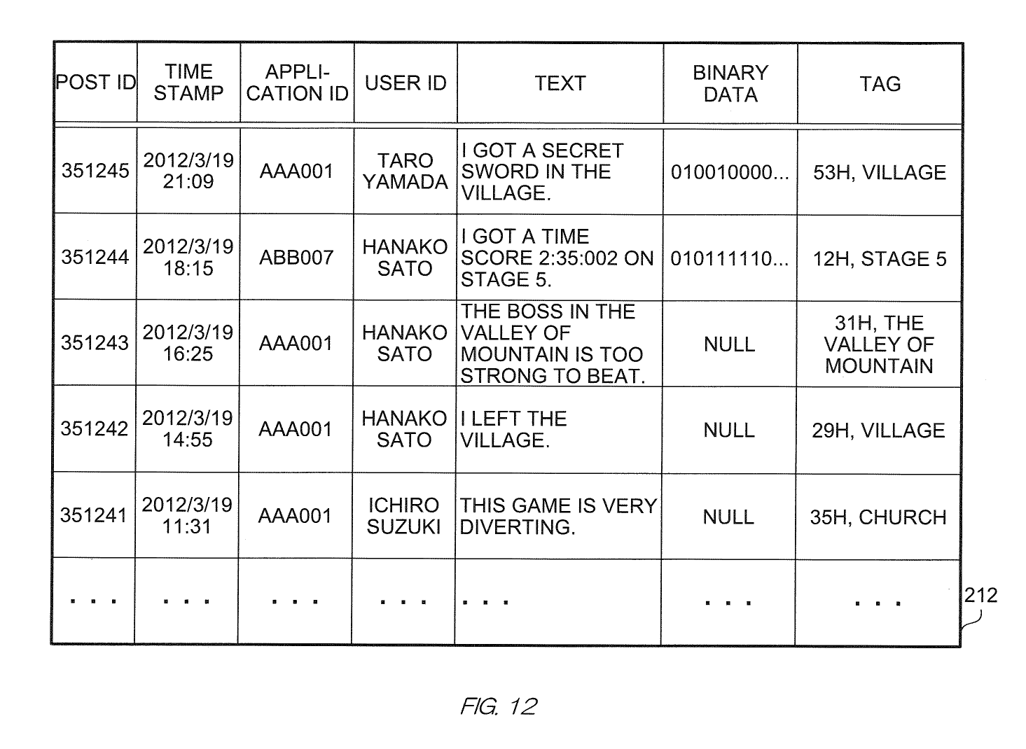

FIG. 12 shows an example of data stored in posted information database 212. Posted information database 212 includes plural data sets. Each data set includes a post ID, a time stamp, an application ID, a user ID, a text (posted text), a set of binary data, and a tag. The post ID is identification information for identifying the posted information. The post ID is given by post server 20 according to a predetermined rule (for example, the post ID is given in order of receiving the posted information). The time stamp shows the time when the posted information is received (or when the posted information is posted). The application ID is identification information for identifying an application program corresponding to the posted information, more specifically, an application program (the application program in the executing state) that was being executed in information-processing device 10 at the time when an instruction to post the subject posted information was made. The user ID is identification information of a user who posts the subject posted information. The posted text consists of character strings input by the user. It is to be noted that handwritten characters (or image) or a text automatically generated by the system may be used instead of or as well as the posted text. The set of binary data is a data set used in the application program identified by the corresponding application ID. More specifically, the set of binary data is a data set generated by the subject application program. The tag is data showing other related information. In this example, the tag shows usage information showing the usage status or progress information showing the progress status of the subject application program. Hereinafter, the usage information or the progress information is referred to as “status information.” The status information shows information that cumulatively changes depending on the usage of the application program, for example, accumulated playing time of a game, or information that discontinuously changes depending on the usage of the application program; for example, a name of a save point in a game. It is to be noted that FIG. 12 merely shows an example, and information included in the posted information is not restricted to the example. A part of information shown in FIG. 12 may be omitted, and/or other information may be added to the example.

There are various examples of status information. The status information may be progress information showing the progress status of the application program. Alternatively, status information may be information usage status showing the usage status of the application program. In a case that the application program is a game application, the status information may be, for example, at least one of a number of times that the user clears the game, a number of times that the user plays the game, a number of times that the user defeats a character in the game, a type of a character in the game, a type of an event that occurs on the game, a number of wins (or losses) in the game, a number of items obtained in the game, the latest stage-number that is cleared by the user, a name of the latest save point, a score or a record (or the best score or the best record), a level of a character in the game, or an achievement (a degree of completion of tasks provided in the game).

In another example, in a case that the application program is a movie player, the status information may be a number of times that a movie is played, accumulated time of playing a movie, or a number of times an instruction to play the movie is made. In yet another example, in a case that the application program is a still image viewer, the status information may be a number of viewed pages, a type of viewed image, or a number of times an instruction to view an image is made.

Referring to FIG. 11 again, when post server 20 receives a request from information-processing device 10, post server 20 extracts (in step S107) at least a part of the posted information from among the posted information recorded in posted information database 212, with reference to the user configuration information. More specifically, in a case that the application ID included in the request for access is “AAA001,” post information having the post ID “351245,” “351243,” “351242,” and “351241” are extracted in the example of FIG. 12. Further, at least a part of posted information that satisfies the condition for restricting the posted information is extracted from the extracted posted information. For example, in a case that the condition for restricting the posted information is “the newest posted information of each user” and “maximum number of sum of the posted information is three,” the posted information having the post ID “351245,” “351243,” and “351241” are extracted.

Post server 20 lists up the extracted posted information (a group of the posted information) in an order according to a predetermined rule; for example, in order of the time stamp. Post server 20 generates (in step S108) data describing the extracted posted information in a predetermined format, for example, in HTML (HyperText Markup Language). Here, the generated data includes a community ID, identifying a community to which access is requested. The community ID is, for example, a part of the URL of the community. Post server 20 transmits (in step S109) the generated data to information-processing device 10 that is a source of the request for access. More specifically, post server 20 transmits a set of posted information and status information, which are recorded in posted information database 212 with the relationship thereof, for each item of posted information included in the group of posted information, to information-processing device 10. It is to be noted that the status information as it is may be transmitted instead of the processed status information.

In step S110, portal software 52 displays an image in accordance with the data received from post server 20. More specifically, portal software 52 receives plural sets of the posted information and the status information. Then, portal software 52 displays the received posted information as well as the corresponding status information with the relationship being visible. It is to be noted that the received information as it is may be displayed instead of the processed information. By the example of step S107, an image shown in FIGS. 2 and 3 is displayed. It is to be noted that the image to show the posted information is not restricted to the example shown in FIG. 3. In the example shown in FIG. 3, the usage information of “53 h” is displayed as it is. In another example, portal software 52 may change the image of at least one item included in the posted information in response to the usage information. More specifically, a shape, a color, or a size of the at least one item may be changed in response to the usage information. For a more detailed example, portal software 52 displays user ID 942 using a different color in a case that the posted information has the usage information (or the posted information is posted by a user who has played the game) from that used in a case that the posted information does not have the usage information (or the posted information is posted by a user who has not played the game). Alternatively, portal software 52 may display an image (an icon or a mark, for example) showing existence/non-existence of the usage information.

According to the flow shown in FIG. 11, a process for accessing post server 20 and a process for providing the UI are executed by the system software. In other words, if the application program does not have a function to access post server 20, a user can easily access a community relating to the application program. For example, a user playing a game can share with other users his/her positive or negative experiences, for example, obtaining a rare item, clearing a stage, or leading to a dead end in the game. In addition, for a developer of an application program, cost for implementing functions to access post server 20 and to provide the UI can be decreased.

In the above description, an example in which portal software 52 is started from the application program via the menu image is described. However, portal software 52 may be started other than via the menu image. In such a case, OS 511 starts portal software 52 when a predetermined command is input during the execution of game application 53. In another example, when game application 53 was being executed when the menu image was called, game application 53 may be terminated instead of be paused. In another example, a device ID (identification information of information-processing device 10) may be used instead of the user ID.

3-1-1-1-2. (Path 2) Call from Game Application 53

In this example, an application program has a UI to start portal software 52. For example, an image of the game includes a button to start portal software 52. If the button is pushed (clicked) by a user, portal software 52 is started. The details of the process are similar to those of path 1.

According to the example, a user can start portal software 52 without inputting a command via the menu image provided by a program other than the game. The user can start portal software 52 by inputting a command via a UI provided by the game.

3-1-1-2. (Path 3) Access from Game Application 53

In this example, an application program has a UI to access post server 20; in other words, the application program has a client function of the posted information sharing system. For example, an image of the game includes a button to access post server 20. If the button is pushed (clicked) by a user, the game application accesses post server 20. In path 3, the application program has a function different from examples of path 1 and path 2. Therefore, a software configuration is first described.

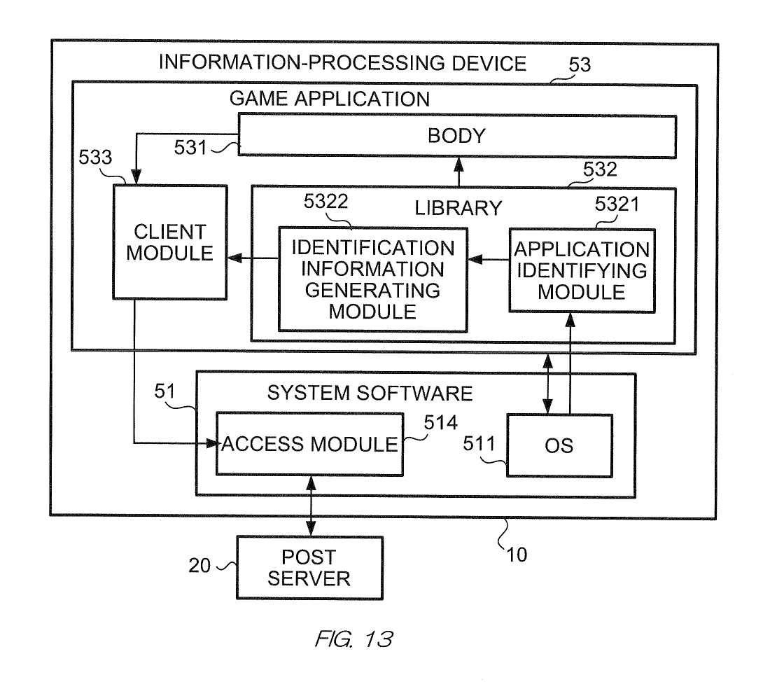

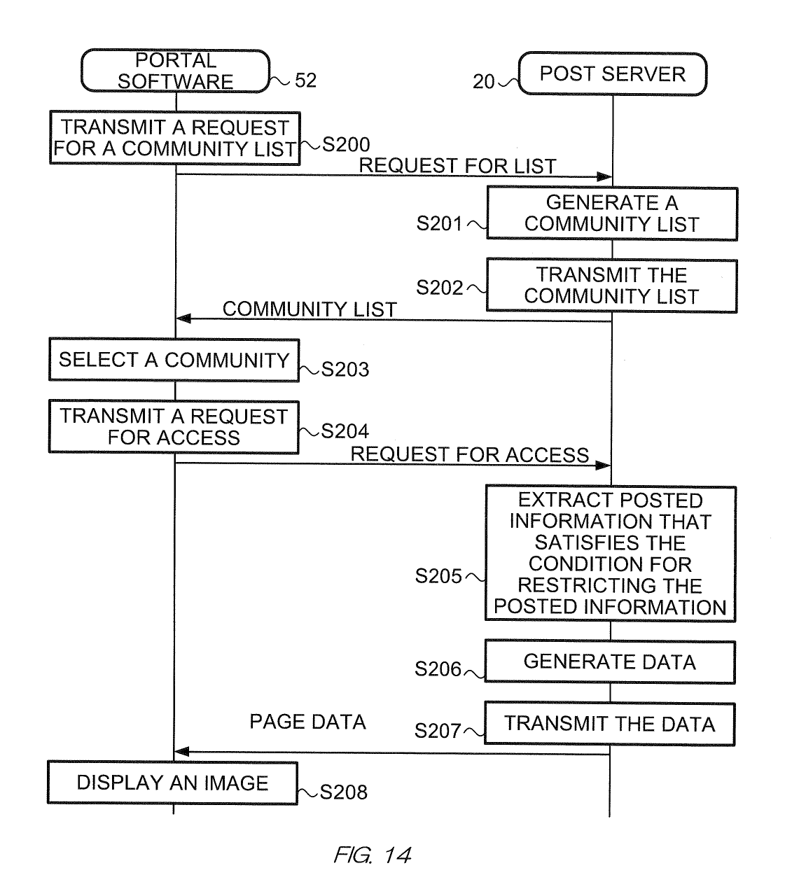

FIG. 13 shows an example of a software configuration relating to path 3. In this example, game application 53 includes body 531 of the game program, library 532, and client module 533. Client module 533 is a client software module of the posted information sharing system, for accessing post server 20 via access module 514. library 532 is a software module used in body 531, and includes, for example, application identifying module 5321 and identification information generating module 5322. Application identifying module 5321 identifies an application program that is being executed. More specifically, application identifying module 5321 obtains an application ID of the executed application program. Identification information generating module 5322 generates identification information (a URL, for example) of a community relating to the application program in the executing state. Library 532 is provided by the provider of the platform of information-processing device 10 (the provider of the game device, for example) for software developers. It is to be noted that application identifying module 512 and identification generating module 513 are not shown in FIG. 13 because these functions are not used in this example.

In the example shown in FIG. 13, application identifying module 5321 is an example of application identifying unit 14, and identification information generating module 5322 is an example of generating unit 18.

If an instruction to access post server 20 is made during the execution of game application 53, body 531 of the game program calls application identifying module 5321. When calling application identifying module 5321, body 531 notifies application identifying module 5321 of the application ID of the game program. Then, application identifying module 5321 calls identification information generating module 5322. Identification information generating module 5322 generates a URL showing a resource of the corresponding community based on the application ID identified by application identifying module 5321. Identification information generating module 5322 includes a table, a function, or a rule to change an application ID into a URL. Identification information generating module 5322 generates a URL from the application ID with reference to the table, the function, or the rule.

Identification information generating module 5322 notifies body 531, which is a source of the call, of the generated URL. Then, body 531 of the game program calls client module 533. When calling client module 533, body 531 of the game program notifies client module 533 of the URL of the community. Client module 533 accesses post server 20 by using the notified URL.

According to the example, a user can access post server 20 without inputting a command via the menu image provided by a program other than the game. Further, since a software developer can implement a client function into the application program, a UI synchronized with the image of the game can be provided.

### 3-1-2. Process in Posted Information Sharing System

Next, description will be given for a process in the posted information sharing system (how a user can use the posted information sharing system). The process in the posted information sharing system includes browsing the posted information, posting the posted information, and managing the community.

### 3-1-2-1. Browsing

Browsing is a process for browsing the posted information. Information stored in post server 20 includes, for example, the posted information and direct messages. The posted information is shared by plural users. The direct message can be viewed by a single specified user. In the following descriptions, viewing this information using portal software 52 will be described.

### 3-1-2-1-1. Browsing Posted Information Relating to Community

FIG. 14 shows an example of a sequence chart illustrating a process for browsing the posted information relating to a community. In step S200, portal software 52 transmits to post server 20 via access module 514 a request for transmitting a list of communities. The request includes the user ID of a user of information-processing device 10. When post server 20 receives the request from information-processing device 10, post server 20 extracts from community database 213 information showing communities to which the user having the user ID included in the request belongs. Post server 20 generates (in step S201) a list of the extracted communities (hereinafter referred to as a “community list”).

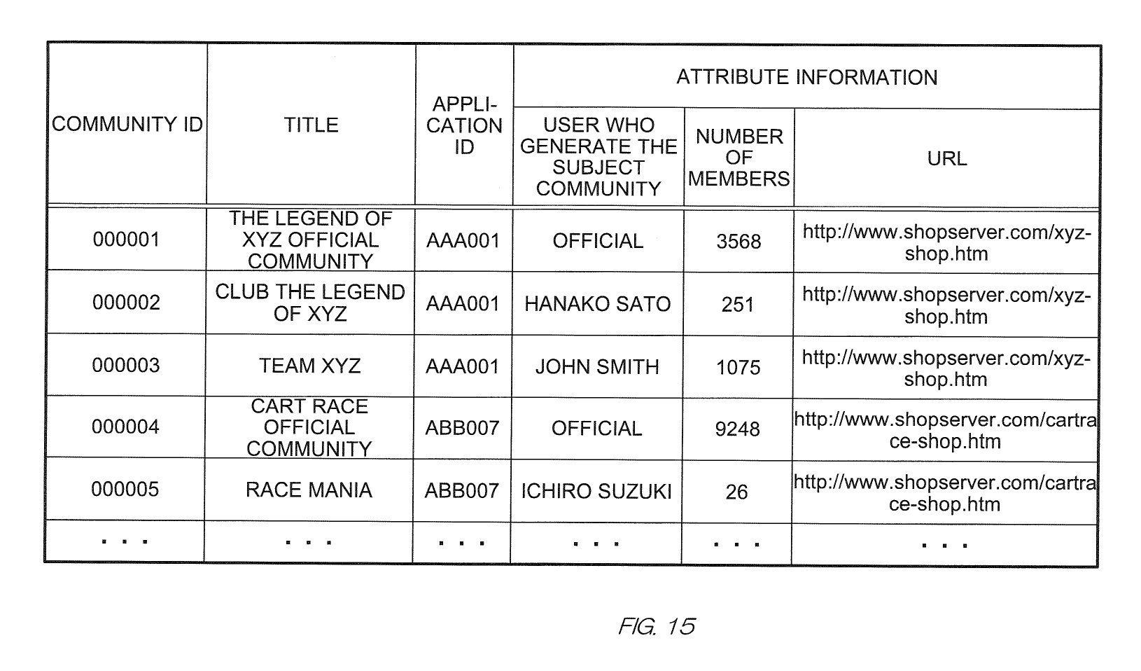

FIG. 15 shows an example of the community list. The community list includes a community ID, a title, an application ID, and attribute information. The community ID is identification information for identifying a community (hereinafter, a specific community that is an object of the description will be referred to as a “subject community”). The community ID is automatically allocated by the system (more specifically, by post server 20). The title is identification information for identifying the subject community, and is input by a user who generates the subject community. The application ID is identification information for identifying an application program corresponding to the subject community. The attribute information shows an attribute of the subject community. In this example, the attribute information includes, for example, the user who generates the subject community, a number of members who belong to the subject community, and a URL of the subject community. The user who generates the subject community is identified by the user ID. In this example, the community is divided into two categories, an official category and a user category. The official community is a community that is generated by a provider of posted information sharing system 1 or a provider of the application program. For the official community, the user is recorded as “official.” The user community is a community that is generated by a user. The number of members shows a number of users who belong to the subject community. The URL shows a resource providing the subject community. It is to be noted that the attribute information may include other information, for example, a required condition to join the subject community.

Referring to FIG. 14 again, post server 20 transmits (in step S202) the generated community list to information-processing device 10 that is the source of the request. When portal software 52 receives the community list, portal software 52 displays an image for prompting a user to select a community. The user selects (in step S203) a community to be browsed via the image. After a community is selected, portal software 52 transmits (in step S204) a request for accessing post server 20 via access module 514. The request includes the user ID of the user of information-processing device 10, and the community ID of the selected community.

When post server 20 receives the request from information-processing device 10, post server 20 extracts (in step S205) posted information that satisfies the condition for restricting the posted information, from the posted information recorded in posted information database 212. Post server 20 generates (in step S206) data describing the extracted posted information in a predetermined format. Post server 20 transmits (in step S207) the generated data to information-processing device 10 that is the source of the request. Portal software 52 receives the data via access module 514. Portal software 52 displays (in step S208) an image in accordance with the data received from post server 20. Details of steps S205 to S208 are similar to those in steps S107 to S110.

### 3-1-2-1-2. Viewing Direct Message

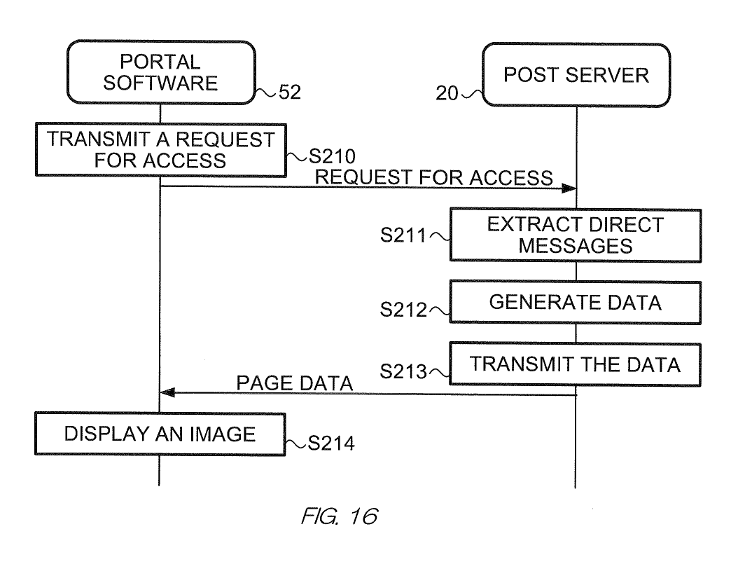

FIG. 16 shows an example of a sequence chart illustrating a process for viewing a direct message. In step S210, portal software 52 transmits to post server 20 via access module 514 a request for accessing a direct message. The request includes a user ID.

When post server 20 receives the request from information-processing device 10, post server 20 extracts (in step S211) direct messages that satisfy the condition for restricting the posted information, from among the direct messages recorded in posted information database 212. It is to be noted that the condition for restricting the posted information includes a condition relating to the direct message. Post server 20 generates (in step S212) data describing the extracted direct message in a predetermined format. Post server 20 transmits (in step S213) the generated data to information-processing device 10 that is the source of the request. Portal software 52 displays (in step S214) an image in accordance with the data received from post server 20. Details of steps S211 to S214 are similar to those in steps S107 to S110.

### 3-1-2-2. Posting

The posting is a process for sharing information with other users. As described in relation to the browsing, information recorded in post server 20 includes the posted information and the direct message. In this example, a set of binary data can be attached to the posted information. Here, description will be given for examples with and without the set of binary data. Furthermore, description will be given for posting a direct message.

### 3-1-2-2-1. Posting Text

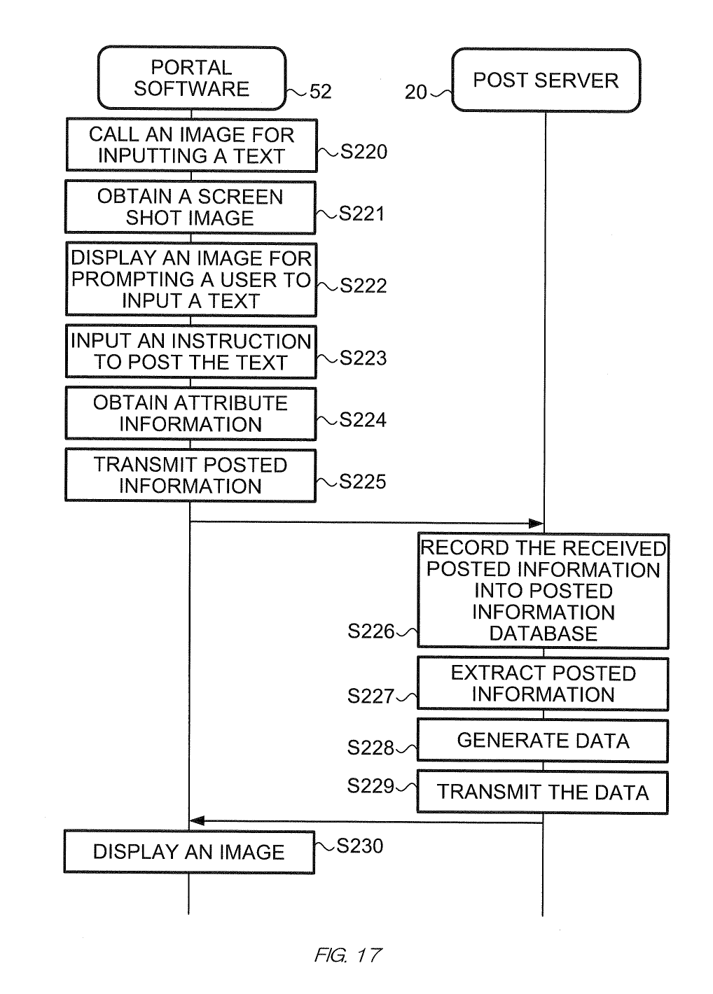

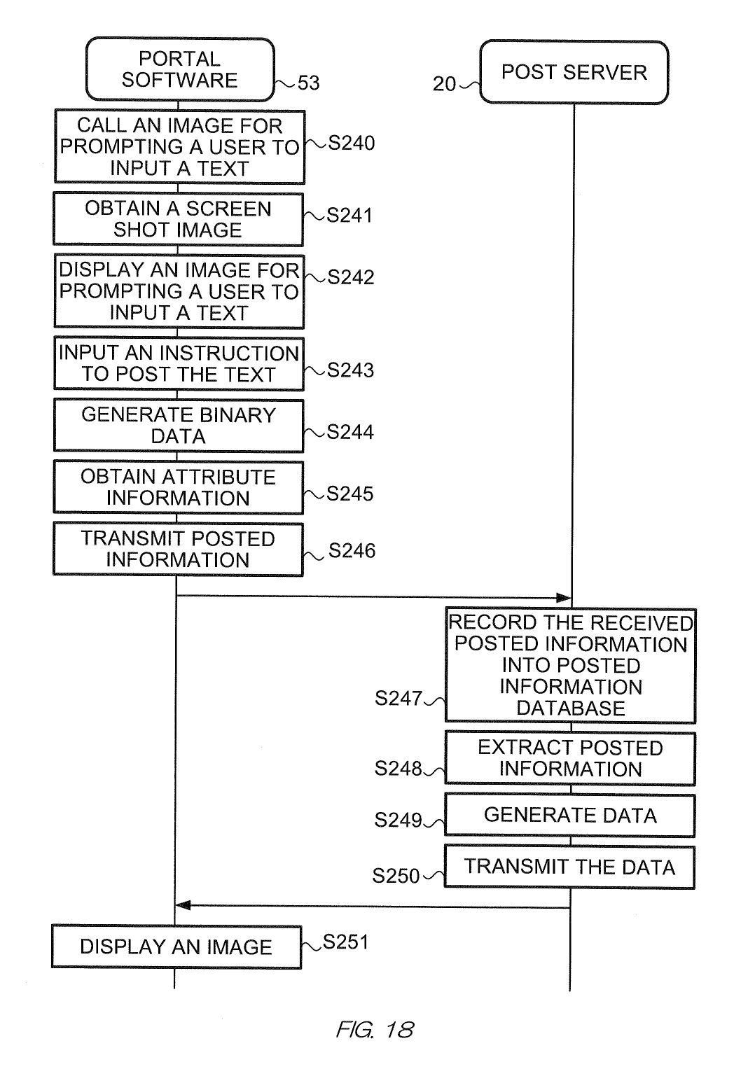

FIG. 17 shows an example of a sequence chart illustrating a process for posting a text. Here, description will be given for an example in which portal software 52 is called during the execution of game application 53, and a text is posted via portal software 52. In step S220, portal software 52 calls an image for inputting a text. The call is triggered by a predetermined event, for example, an instruction to start portal software 52 is input.

In step S221, portal software 52 obtains a screen shot image of the application program in the executing state. The application program “in the executing state” is an application program that was being executed at the time when the instruction to start portal software 52 was made, and, in this example, game application 53 is the application program in the executing state. While portal software 52 is activated, game application 53 is temporarily paused. As has already been described, while game application 53 is paused, data used for game application 53 is expanded in memory 102. Portal software 52 generates a screen shot image based on the data of game application 53 expanded in memory 102.

In step S222, portal software 52 displays an image for prompting a user to input a text to post. The image is shown in FIG. 2, for example. The user inputs a text to be posted, via the image. After completing the input of the text to be posted, the user inputs (in step S223) an instruction to post the text, by clicking post button 93, for example.

In step S224, portal software 52 obtains attribute information used for the posted information. In this example, the attribute information includes a time stamp, a user ID, an application ID, a community ID, and usage information. The time stamp shows the current time. The application ID is identification information of the application program that is paused. The usage information is the usage information of the application program that is paused. In this example, the usage information shows accumulated playing time of the game. The time stamp, the user ID, the application ID, and the usage information are held by OS 511. Portal software 52 obtains from OS 511 the time stamp, the user ID, the application ID, and the usage information. The community ID is identification information of a community that portal software 52 is accessing. The community ID is held by portal software 52.

For example, in a case that an accumulated playing-time of the game is used as the usage information, OS 511 keeps the accumulated playing-time by a process independent from the process shown in FIG. 17. Memory 102 stores the usage information of application programs that have been played in the subject information-processing device 10 as well as a corresponding application ID with the relationship thereof. For example, in a case that ten game applications have been played in the subject information-processing device 10, ten sets of application ID and accumulated playing-time are stored in memory 102. When an application program is started, OS 511 measures by a timer (not shown in the figures) a time during which the application program is executed. At a predetermined timing (for example, periodically, or when the application program is terminated), OS 511 adds the measured time to an accumulated playing-time of the subject application program, from among the plural accumulated playing-times stored in memory 102. It is to be noted that the accumulated playing time may be recorded for each user.

Referring to FIG. 17 again, in step S225, portal software 52 transmits the posted information to post server 20 via access module 514. The subject posted information includes the attribute information obtained in step S224.

According to the example, a set of posted information includes the usage information or the progress information of the corresponding application program. In other words, an image including the posted text, identification information of the application program, and the usage information or the progress information are displayed, with relationship thereof. The posted text is freely input by a user and the identification information and the progress information are automatically provided by the system. In posted information sharing system 1, the progress information showing the progress status of a game is provided as well as the posted text relating to the game, for users of information-processing devices 10. In other words, objective information for determining helpfulness (or reliability) of the posted information, for users of information-processing devices 10, is provided. For example, with regard to a game, an example is considered with two items of posted information, “this game is boring” and “this game is very diverting.” The former text is posted by a user whose accumulated playing-time is one hour. The latter text is posted by another user whose accumulated playing-time is fifty hours. A user of information-processing device 10 can determine that the latter text is more reliable than the former text.

In step S226, post server 20 records the received posted information into posted information database 212. Post server 20 extracts (in step S227) posted information that satisfies the condition for restricting the posted information from posted information database 212. Post server 20 generates (in step S228) data showing the extracted posted information in a predetermined format. Post server 20 transmits (in step S229) the generated data to information-processing device 10 that is the source of the request. Portal software 52 displays (in step S230) an image in accordance with the data received from post server 20. Details of steps S227 to S230 are similar to those of steps S107 to S110.

### 3-1-2-2-2. Posting Binary Data

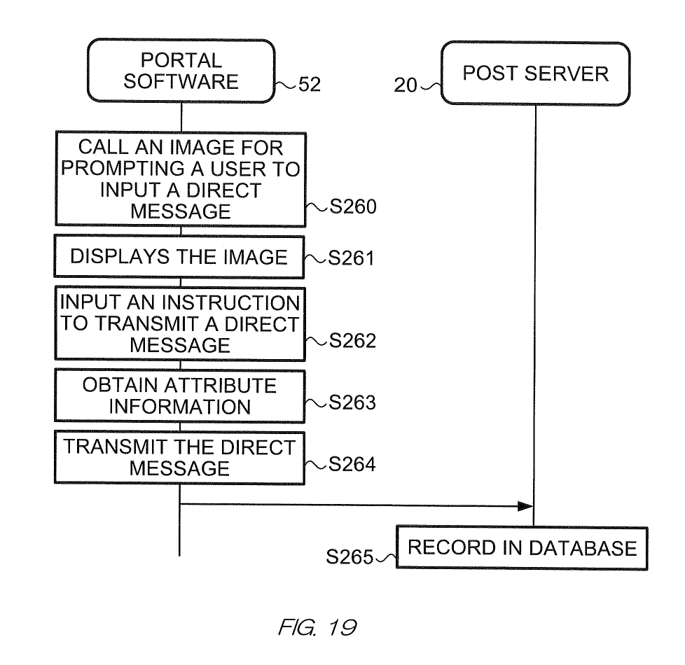

FIG. 18 shows an example of a sequence chart illustrating a process for posting information including a set of binary data. Here, description will be given for an example in which game application 53 transmits a posted text and a corresponding set of binary data. In step S240, game application 53 calls an image for prompting a user to input a text. The call of the image is triggered by a predetermined event, for example, a predetermined command is input during the execution of the game.

In step S241, game application 53 obtains a screen shot image of the application program in the executing state. In step S242, game application 53 displays the image for prompting a user to input a text. After completing an input of a text, the user instructs (in step S243) to post the text. Details of steps S241 to S243 are similar to those in steps S221 to S223.

In this example, the image for prompting a user to input a text provides a UI to select a set of binary data to be attached to the posted text. For example, in a case that binary data shows an item used in the game, the image provides a UI to select an item from among items obtained in the game by the user, to be shared in the community. In step S244, game application 53 generates a set of binary data showing an item selected via the UI.

In step S245, game application 53 obtains attribute information used for the posted information. In step S246, game application 53 transmits the posted information to post server 20. The subject posted information includes a set of binary data generated in step S244, and the attribute information generated in step S245.

In step S247, post server 20 records the received posted information into posted information database 212. Post server 20 extracts (in step S248) posted information that satisfies the condition for restricting the posted information from posted information database 212. Post server 20 generates (in step S249) data showing the extracted posted information in a predetermined format. Post server 20 transmits (in step S250) the generated data to information-processing device 10 that is the source of the request. Portal software 52 displays (in step S251) an image in accordance with the data received from post server 20. Details of steps S247 to S251 are similar to those of steps S226 to S230.

### 3-1-2-2-3. Posting Direct Message

FIG. 19 shows an example of a sequence chart illustrating a process for posting a direct message. Here, description will be given for an example in which portal software 52 posts a direct message. In step S260, portal software 52 calls an image for prompting a user to input a direct message. The calling of the image is triggered by a predetermined event, for example, a predetermined command is input via portal software 52.

In step S261, portal software 52 displays the image for prompting a user to input a direct message. The image includes a box for inputting an ID of a user to whom the direct message is sent, and another box for inputting a message. After completing the input of the message, the user instructs (in step S262) to transmit the direct message. In step S263, portal software 52 obtains attribute information used for the direct message. In this example, the user ID of the sender (source) and the user ID of the destination, are used as the attribute information. In step S264, portal software 52 transmits the direct message to post server 20 via access module 514. The direct message includes the attribute information obtained in step S263. In step S265, the direct message is recorded in posted information database 212.

3-2. Access to Post Server when Game Application is not Executed

When game application 53 is not executed, for example, from booting information-processing device 10 to starting game application 53, a user can access post server 20. In such a case, the user instructs that portal software 52 be started.

As already described, when portal software 52 is started while game application 53 is being executed, portal software 52 accesses a community whose URL is notified by OS 511. However, in this example, OS 511 does not notify portal software of the URL. In this case, portal software 52 transmits a request for accessing post server 20 without designating a specific community. More specifically, portal software 52 transmits a request for accessing a predetermined resource; for example, the home directory.

When post server 20 receives the request without designating a community, post server 20 refers to the user configuration information. The user configuration information includes information to identify items shown in a displayed image (hereinafter referred to as “home image”) corresponding to the home directory. The home image of the posted information sharing system includes plural items of posted information in order of their time stamps. Further, the home image includes a list of all communities or a part of the communities that satisfies a predetermined condition (for example, communities to which the user belongs). Post server 20 generates data showing this information. Post server 20 transmits the generated data to information-processing device 10 that is the source of the request. The data includes URLs showing resources included in the list.

When portal software receives the data of the home image, portal software 52 displays the home image in accordance with the received data. If the user selects a community from the list in the home image, portal software 52 transmits to post server 20 a request for accessing the selected community.

When post server 20 receives the request, post server 20 extracts posted information that satisfies the condition for restricting the posted information, from posted information database 212. Post server 20 generates data showing the extracted posted information. Post server 20 transmits the generated data to information-processing device 10 that is the source of the request. The processes are similar to those of steps S107 to S109.

A displayed image in accordance with the data transmitted from post server 20 includes a text box for inputting a posted text, and a button for inputting an instruction to post the text. If the user inputs a text in the text box and pushes the button, portal software 52 obtains attribute information used for the posted information, similarly to step S224. It is to be noted that, in this case, since there is no application program whose execution is paused, portal software 52 obtains the application ID of the application program corresponding to the community that is being accessed. The application ID is notified by post server 20 and held by portal software 52.

The attribute information is similar to that described in step S224. However, in this case, the usage information of the application program corresponding to the community that is being accessed may not be stored in memory 102. In this case, portal software 52 transmits to server 20 the posted information including information showing existence/non-existence of the usage information (showing non-existence of the usage information in this example). In other words, portal software 52 transmits to server 20 the posted information without the usage information (or including null usage information).

Post server 20 records the received posted information into posted information database 212. For the posted information that does not include the usage information (or includes null usage information), post server 20 records null string as the usage information into posted information database 212.

Post server 20 again extracts posted information that satisfies the condition for restricting the posted information from posted information database 212. Post server 20 generates data showing the extracted posted information. Post server 20 transmits the generated data to information-processing device 10 that is the source of the request. These processed are similar to those of steps S107 to S109.

The posted information recorded in posted information database 212 is divided into two categories, one is the posted information including some (non-null) usage information and the other is the posted information including null usage information. In information-processing device 10, non-null usage information and null usage information are displayed so as to be visually different from each other. In other words, portal software 52 displays the posted information corresponding to the null usage information showing that the corresponding application program has not been used, and the posted information corresponding to the non-null usage information showing that the corresponding application program has been used, so as to be visually different from each other. Displaying items of information to be visually different from each other means, for example, displaying at least one of character strings, a user image, and a posted text in different colors. In another example, displaying items of information to be visually different from each other may be displaying at least one of character strings and a posted text in different fonts. In yet another example, portal software 52 may add a specific image (for example, an icon or a mark) to only one of the items of posted information including the null usage information and the posted information including the non-null usage information.

According to the example, a user can easily determine whether the posted information is posted by a user who has played the game or a user who has not played the game, compared with a case where these two items of posted information are not shown as visually different from each other.

It is to be noted that if there is no application program in the executing state, portal software 52 may transmit to post server 20 posted information without an application ID (or including a null application ID). In such a case, post server 20 records the received posted information as well as the application ID corresponding to the community that is being accessed, into posted information database 212.

The technology is not restricted to the embodiment described above. Various modifications can be applied to the exemplary embodiment. Some modifications will be described below. Two or more modifications from among the following modifications may be combined.

### 4-1. First Modification

A timing at which the usage information or the progress information is obtained in information-processing device 10 when posting the posted information, is not restricted to the above embodiment. The timing may be any timing relating to posting the text. For example, the timing may include at least one of the following timings:

(1) the time when an instruction is made to display the UI for inputting the posted text (an example of the above embodiment);

(2) the time when an input of the text is started (in other words, the time when the first character is input);

(3) the time when an input of the text is completed (in other words, the time when the last character is input or a button for instructing completion of the input is pushed);

(4) the time when the posted text is transmitted (in other words, the time when post button 93 is pushed);

(5) the time when the application program is paused; and

(6) a periodical timing nearest to one of the timings (1) to (5).

It is to be noted that the posted text received by posted information receiving unit 32 relates to the application program in the executing state, and the application program in the executing state may be an application program that was being executed at one of the above timings (1) to (6).

### 4-2. Second Modification

The software configuration of information-processing device 10 is not restricted to the example described in the embodiment. For example, in the above embodiment, access module 514 is included in the system software. However, an access module may be included in an application program. In another example, system software 51 may include a function corresponding to portal software 52. As long as the functions shown in FIG. 4 are implemented, assignment of the functions to an application program and the system software may be performed by any method. Alternatively, a single program may include all the functions described above.

### 4-3. Third Modification

A method for identifying by application identifying unit 14 the application program in the executing state, is not restricted to the example described in the above embodiment. In the above embodiment, description is given for an example in which OS 511 monitors the application program in the executing state, and application identifying module 512 identifies the application program in the executing state by the application ID notified by OS 511. However, the application program may notify its own application ID to application identifying module 512. In another example, application identifying unit 14 may transmit an inquiry of the application ID of the application program in the executing state, and may notify application identifying module 512 of the application ID that is notified by a server. In such a case, the server holds the application ID of the application program in the executing state by inquiring to the system software of information-processing device 10 or by inquiring to the application program, or by receiving notification from the system software or an application program.

### 4-4. Fourth Modification

At least a part of the functional elements shown in FIG. 5 may be omitted. For example, information-processing device 10 may not include application identifying unit 14, access instructing unit 15, image obtaining unit 16, or information obtaining unit 17.

### 4-5. Fifth Modification

Information-processing device 10 may have a function to execute plural application programs in parallel, a so-called multi task function. In this case, application identifying unit 14 identifies as the application program in the executing state one application program that is active (more specifically, is executed in the foreground, or is focused for inputting) at the timing when access to post server 20 is instructed, from among plural application programs parallelly executed.

### 4-6. Sixth Modification

Portal software 52 may be preinstalled in information-processing device 10. In other words, even in a case that portal software 52 is not the system software, portal software 52 may be installed when game application 53 is executed.

### 4-7. Seventh Modification

In the above embodiment, any user can access a community relating to an application program independent of experience of using the application program. However, access to the community may be restricted to a user who has used the application program. The restriction may be set for each community.

### 4-8. Further Modification

Information-processing device 10 is not restricted to a console type game device. Information-processing device 10 may be a device other than a console type game device, for example, a portable game device, a personal computer, a mobile phone, a PDA (Personal Digital Assistants), or a tablet device. Further, an application program executed in information-processing device 10 is not restricted to a game application. The application program may be other than the game application, for example, a word processing application, educational application, or any other utility software.

The hardware configuration of information-processing device 10 is not restricted to the example shown in FIG. 7. Information-processing device 10 may have any hardware configuration as long as the functions shown in FIG. 4 can be implemented in information-processing device 10.

Sequence charts described in the above embodiment are merely examples. The order of the processes is not restricted to the examples.

Posted information is not restricted to information input by a user. A fixed phrase generated by the system or the application program may be used as the posted information.

In the above embodiment, a single information-processing device functions as the information-processing system. However, the information-processing system may include a server device as well as the information-processing device. In such a case, a functional unit of the information-processing system may be implemented a process by a processor of the information-processing device, a process by a processor of the server device, or a process by cooperation of the processor of the information-processing and the processor of the server device. The processes may be assigned to the information-processing device and the server device in any way according to common knowledge of those skilled in the art. Further, the server device may be identical to or different from post server 20.

The application program executed in information-processing device 10 is not restricted to an application program that is provided in a storage medium. The application program may be provided by download via a network such as the Internet. Further, the system software of information-processing device 10 may be provided by a storage medium or by download.

What is claimed is:

1. A posted information sharing system comprising
an information-processing system and
a server, wherein
the information-processing system includes:
an executing unit configured to execute an application program;
a first storage unit configured to store usage information or progress information, the usage information showing a usage status of the application program, the progress information showing a progress status of the application program;
a generating unit configured to generate posted information relating to the application program, based on an input by a user;
a first transmitting unit configured to transmit to the server the posted information along with first information, the first information being based on the usage information or the progress information that is stored in the first storage unit and corresponds to the application program; and
a requesting unit configured to transmit a request to the server to transmit posted information,
the server includes:
a first receiving unit configured to receive the posted information and the first information transmitted from the information-processing system;
a second storage unit configured to store the posted information and information showing the usage status or the progress status relating to the posted information, based on the first information received by the first receiving unit; and
a second transmitting unit configured to transmit, in response to the request transmitted from the information-processing system, the posted information along with second information, the second information being based on the usage status or the progress status relating to the posted information, and
the information-processing system further includes:
a second receiving unit configured to receive the posted information and the second information transmitted from the server; and
a display control unit configured to control a display to display the posted information and the usage status or the progress status relating to the posted information, based on the posted information and the second information received by the second receiving unit.

2. The posted information sharing system according to claim 1, wherein
the executing unit is further configured to execute selectively at least one application program from among a plurality of application programs,
the first storage unit is further configured to store the usage information or the progress information for each of the plurality of application programs, and
the first transmitting unit is further configured to transmit the first information relating to one application program, from among the plurality of application programs, corresponding to the posted information generated by the generating unit.

3. The posted information sharing system according to claim 1, wherein the generating unit is further configured to generate the posted information relating to the one application program when the one application program is in an executing state, and
the first transmitting unit is further configured to transmit the posted information and the first information relating to the one application program in the executing state.

4. The posted information sharing system according to claim 1, wherein
the first storage unit is further configured to store a screen shot image relating to the application program executed by the executing unit, as the progress information.

5. The posted information sharing system according to claim 1, wherein
if the first storage unit does not store the usage information or the progress information of the application program relating to the posted information, the first transmitting unit is further configured to transmit information showing that the application program has not been used or has not progressed, as the first information.

6. An information-processing system comprising:
an executing unit configured to execute an application program;
a storage unit configured to store usage information or progress information, the usage information showing a usage status of the application program, the progress information showing a progress status of the application program;
a generating unit configured to generate posted information relating to the application program, based on an input by a user; and
a transmitting unit configured to transmit to the server the posted information along with first information, the first information being based on the usage information or the progress information that is stored in the first storage unit and corresponds to the application program.

7. An information-processing device comprising:
an executing unit configured to execute an application program;
a storage unit configured to store usage information or progress information, the usage information showing a usage status of the application program, the progress information showing a progress status of the application program;
a generating unit configured to generate posted information relating to the application program, based on an input by a user; and
a transmitting unit configured to transmit to a server the posted information along with first information, the first information being based on the usage information or the progress information that is stored in the first storage unit and corresponds to the application program.

8. A computer-readable non-transitory storage device storing a program causing a computer device to execute a process, the process comprising:
storing, in a storage unit, usage information or progress information, the usage information showing a usage status of the application program, the progress information showing a progress status of the application program;
generating posted information relating to the application program, based on an input by a user; and
transmitting to a server the posted information along with first information, the first information being based on the usage information or the progress information that is stored in the storage unit and corresponds to the application program.

9. A server comprising:
a receiving unit configured to receive posted information along with usage information or progress information of a user who posts the posted information, the usage information showing a usage status of the application program, the progress information showing a progress status of the application program;
a storage unit configured to store the posted information and information showing the usage status or the progress status relating to the posted information, based on the first information received by the receiving unit; and
a transmitting unit configured to transmit to the information-processing device the posted information along with second information, the second information being based on the usage status or the progress status relating to the posted information, and

10. An information-processing device comprising:
a transmitting unit configured to transmit a request to a server providing posted information, the request including identification information of an application program,
a receiving unit configured to receive the posted information and usage information or progress information, the usage information showing a usage status corresponding to the application program identified by the identification information, the progress information showing a progress status of the application program, the posted information and the usage information or the progress information being transmitted in response to the request; and
a display control unit configured to control a display to display the posted information and the usage status or the progress status relating to the posted information, based on the posted information and the second information received by the receiving unit.

11. An information-processing method comprising:
executing, by an executing unit, an application program;
storing, in a storage unit, usage information or progress information, the usage information showing a usage status of the application program, the progress information showing a progress status of the application program;
transmitting to a server posted information along with first information, the posted information being generated based on an input by a user, the first information being based on the usage information or the progress information that is stored in the storage unit and corresponds to the application program.

12. An information-processing method comprising:
transmitting a request to a server providing posted information, the request including identification information of an application program,
receiving the posted information and usage information or progress information, the usage information showing a usage status corresponding to the application program identified by the identification information, the progress information showing a progress status of the application program, the posted information and the usage information or the progress information being transmitted in response to the request; and
controlling a display to display the posted information and the usage status or the progress status relating to the posted information, based on the received posted information and the second information.

13. An information-processing system comprising:
a first information-processing device;
a second information-processing device; and
a server device providing a service to provide posted information, wherein
the first information-processing device includes:
an executing unit configured to execute an application program;
a first storage unit configured to store usage information or progress information, the usage information showing a usage status of the application program that has been executed by the executing unit, the progress information showing a progress status of the application program that has been executed by the executing unit; and
a first transmitting unit configured to transmit to the server device the posted information relating to the application program along with one of the usage information, the progress information, or status information of the application program, the posted information being generated based on an input by a user, the status information showing existence or non-existence of the usage information or the progress information,
the server device includes:
a second storage unit configured to store a plurality of sets of the posted information and one of the usage information, the progress information, or the status information;
a second transmitting unit configured to transmit to a source device of a request, at least a part of the plurality of sets of the posted information and one of the usage information the progress information, or the status information that satisfies a condition, and
the second information-processing device includes:
a third transmitting unit configured to transmit the request to the server device;
a receiving unit configured to receive the posted information and one of the usage information, the progress information, or the status information transmitted from the server device; and
a display control unit configured to control a display unit to display the posted information and one of the usage information, the progress information, or the status information received by the receiving unit.
